(19) United States
(12) Patent Application Publication
(10) Pub. No.: US 2016/0041692 A1
(43) Pub. Date: Feb. 11, 2016

(54) GUIDE LIGHT PLATE OPTICAL TOUCH DEVICE

(71) Applicant: CHIH-HSIUNG LIN, New Taipei City (TW)

(72) Inventor: CHIH-HSIUNG LIN, New Taipei City (TW)

(73) Assignee: inFilm Optoelectronic Inc., Grand Cayman (KY)

(21) Appl. No.: 14/806,641

(22) Filed: Jul. 22, 2015

(30) Foreign Application Priority Data
Aug. 6, 2014 (TW) 103127000

(51) Int. Cl. G06F 3/042; H04N 9/04

(52) U.S. Cl. CPC G06F 3/0421; G06F 3/0423; H04N 9/045; G06F 2203/04109

(57) ABSTRACT

A guide light plate optical touch device comprises a guide light plate, an image capturing unit, an optical signal emitting unit, a microprocessor, and an optical signal processing unit; when the guide light plate is touched, at least two lights passing though the touch point carry newly generated low frequency vibration signals or further generate FTIR signals such that the optical signal processing unit obtains at least two unusual signal values; then the microprocessor detects the signal values sequentially output by the optical signal processing unit in a period and obtains the location information of the touch point based on the time points appearing in the period with respect to the two unusual signal values so as to output a corresponding touch signal.

### CROSS-REFERENCE TO RELATED APPLICATIONS

The application claims priority of Taiwan Patent Application No. 103127000 filed on Aug. 6, 2014, the disclosure of which is incorporated herein by reference.

### BACKGROUND OF THE INVENTION

1. Field of the Invention

The present invention relates to a touch device, and, more particularly, to a touch device which detects locations of lights carrying modulation signals being touched during propagating in a guide light plate and generates a corresponding control signal.

2. Description of Related Art

There are many touch devices in association with guide light plates; for instance. U.S. Pat. No. 7,432,893 discloses an input device based on frustrated total internal reflection (abbreviated as FTIR) in which lights emitting from at least two light sources at two different locations are guided into a guide light plate to conduct total internal reflective propagation, wherein the light emitting from respective light source is distributed in the entire light plate uniformly, and a light sensing array is disposed at peripheral sides of the guide light plate to detect the respective light generated by the light sources. When an object contacts the surface of the guide light plate, the total internal reflections of the lights in the guide light plate are frustrated to attenuate the lights passing through the contact area; a processor is utilized to determine location of the object with triangulation according to the attenuation signals issued by the at least two light sources at different locations.

U.S. Patent application publication Numbers US2011074735 (corresponding to Taiwan Patent Publication No. 201005606), US20130044073 (corresponding to Taiwan Patent publication No. 201203052), US20120162144. US20120268403, and 0520130021300 disclose touch techniques related to the guide light plate.

The preceding touch techniques related to the guide light plate require lights issued by at least two light sources at different locations being guided into the guide light plate to perform the total internal reflective propagation and utilize a processor to determine location of the object according to at least two light sensors arrays detecting the attenuation signals issued by the at least two light sources at different locations and generate a corresponding touch signal. However, if the lights are projected into the guide light plate along unspecific incident angles, the total internal reflections incapable of being performed in the guide light plate. It is very difficult to adjust a light incident angle precisely, and it is required to provide guide light components which increase thickness or area of the touch device. In addition, if the touch point has a very small area, such as the tip of a toothpick, it is incapable of frustrating the total internal reflection in the guide light plate to obtain the corresponding touch signal.

Although U.S. Patent Application Publication No. US-2015-0193087-A1 disclosed by the inventor and entitled “LIGHT VIBRATION TOUCH APPRATUS” is capable of solving the preceding mentioned problems, it increases the cost and volume once a scanning device is used with the touch apparatus.

### SUMMARY OF THE INVENTION

In order to improve the conventional guide light plate touch device, the present invention is proposed.

The main object of the present invention is to provide a guide light plate optical touch device with which when the guide light plate is touched, at least two lights passing though the touch point carry newly generated low frequency vibration signals or further generate FTIR signals such that the optical signal processing unit obtains at least two unusual signal values, and the microprocessor detects the signal values sequentially output by the optical signal processing unit in a period and obtains the location information of the touch point based on the time points appearing in the period with respect to the two unusual signal values so as to output a corresponding touch signal; even if the area of the touch point is extremely small, the lights passing through the touch point are capable of carrying newly generated low frequency vibration signals, and the location information of the touch point can be obtained as well so as to enhance function of the touch device practically.

Another object of the present invention is to provide a guide light plate optical touch device with which the lights emitted by the optical signal emitting unit cover a range over 90 degrees to irradiate the entire area inside the guide light plate such that no scanning device has to be used to lower the cost and reduce the volume; further, the image capturing unit includes a photosensitive array and a lens with which the lens captures a large area image with small area photosensitive array to lower the cost as well without providing large area multiple photosensitive components surrounding the guide light plate.

The guide light plate optical touch device according to the present invention comprises:

a guide light plate having a peripheral surface, a lower surface and an upper surface with an operation zone;

at least a strip-shaped retro-reflector;

at least a strip-shaped reflection films;

a microprocessor; an optical signal emitting unit disposed near a corner of the guide light plate;

an image capturing unit disposed near the optical signal emitting unit, and including a photosensitive array and a lens, wherein the photosensitive array provides a plurality of photosensitive units;

an optical signal processing unit electrically connecting with said microprocessor and the image capturing unit, detecting signals output by the photosensitive units, processing the signals and obtaining multiple signal values corresponding to the signals of the photosensitive units, and transmitting the signal values to the microprocessor;

wherein at least one of the retro-reflectors and one of the reflector films are disposed at the peripheral surface of the guide light plate to guide lights emitted by the optical signal emitting unit into the guide light plate, retro-reflect the lights toward the optical signal emitting unit, and further guide the light into the image capturing unit; when the operation zone on the upper surface of the guide light plate is touched, at least two of the photosensitive units of said photosensitive array sense at least two lights passing through a touch point and output an newly generated low frequency vibration signal respectively, or generating at least one of FTIR signals to allow the optical signal processing unit to obtain two unusual signal values; the microprocessor detects the signal values output by the optical signal processing unit sequentially in a period and obtains location information of the touch point based on time points corresponding to the two unusual signal values appearing in the period, and outputs a corresponding touch signal.

Wherein the image capturing unit is disposed under the lower surface of the guide light plate; the first guide light unit contacts the lower surface; the lights, which are retro-reflected toward the optical signal emitting unit, are guided into the image capturing unit by the first guide light unit.

Wherein the optical signal emitting unit is disposed under the lower surface of the guide light plate; the second guide light unit contacts the lower surface; the lights, which are emitted by the optical signal emitting unit, are guided into the guide light plate by the second guide light unit.

Wherein the lights emitted by the optical signal emitting unit carry modulation signals; most of the photosensitive units sense most of the lights which do not pass through the touch point and output most of the modulation signals to allow the optical signal processing unit to obtain most of the normal signals corresponding to the modulation signals.

Wherein the guide light plate is rectangular-shaped with four sides; the peripheral surface of the guide light plate at two of the sides contacts two retro-reflectors; the two retro-reflectors have an end thereof close to the optical signal emitting unit respectively; the peripheral surface of the guide light plate at other two sides are adhered with two reflection films respectively.

Wherein the guide light plate is rectangular-shaped with four sides; the peripheral surface of the guide light plate at one of the sides contacts one retro-reflector; the peripheral surface of the guide light plate at other three sides are adhered with three reflection films respectively.

Wherein the guide light plate is made of guide light material in a form of bendable or unbendable plate; the optical signal emitting unit is LASER plane light emitting unit; the first and second guide light units are optical prisms with triangle cross-sections.

Wherein the upper surface of the guide light plate forms the operation zone corresponding to an internal area with which the lights propagates in the guide light plate.

Further benefits and advantages of the present invention will become apparent after a careful reading of the detailed description with appropriate reference to the accompanying drawings.

### BRIEF DESCRIPTION OF THE DRAWINGS

FIG. 1 is a top view of the first embodiment of a guide light plate optical touch device in accordance with the present invention showing an object touching the touch device;

FIG. 2 is a side view of the first embodiment of a guide light plate optical touch device showing lights propagating therein;

FIG. 3 is a graph illustrating signal values with respect to a single photosensitive array in accordance with the present invention;

FIG. 4 is a side view of the second embodiment of a guide light plate optical touch device in accordance with the present invention;

FIG. 5 is a side view of the third embodiment of a guide light plate optical touch device in accordance with the present invention.

### DETAILED DESCRIPTION OF THE INVENTION

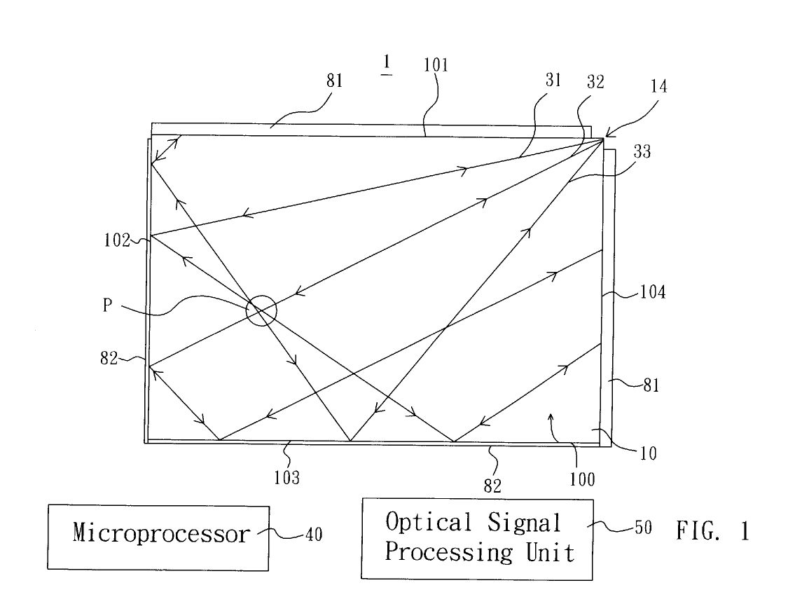

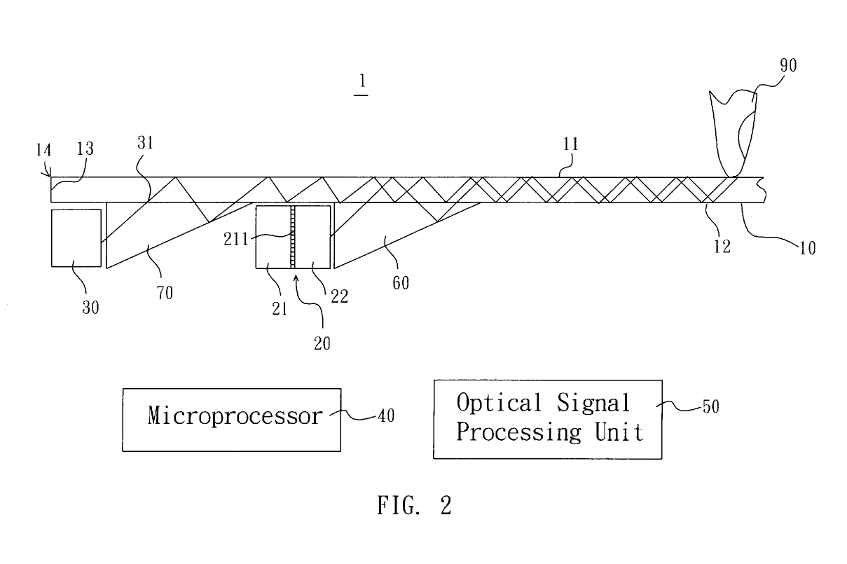

Referring to FIGS. 1 and 2, the first embodiment of a guide light plate touch device 1 according to the present invention comprises a guide light plate 10, an image capturing unit 20, an optical signal emitting unit 30, a microprocessor 40, an optical signal processing unit 50, a first guide light unit 60, a second guide light unit 70, at least a strip-shaped retro-reflector 81, and at least a strip-shaped reflective film 82.

The guide light plate 10 has an upper surface 11, a lower surface 12, and a peripheral surface 13 formed by lateral edges of the guide light plate 10. The guide light plate 10 is rectangular with four sides 101, 102, 103, 104. The guide light plate 10 is a bendable or unbendable plate made of guiding light material such as acrylic, resin or glass. The first guide light unit 60 and the second guide light unit 70 preferably are optical prisms with a triangle cross-section respectively.

In the first embodiment, the image capturing unit 20 and the optical signal emitting unit 30 are disposed at the lower surface 12 close to a corner 14 of the guide light plate 10 respectively. The first and second guide light units 60, 70 are disposed at the lower surface 12. Both the image capturing unit 20 and the optical signal emitting unit 30 are positioned next to the first guide light unit 60 and the second guide light unit 70, respectively. Two strip-shaped retro-reflectors 81 have an end thereof beside the optical signal emitting unit 30 respectively to contact the peripheral surface 13 of guide light plate 10 at the two sides 101, 104. Two strip-shaped reflection films 82 contact the peripheral surface 13 of the guide light 10 at the two sides 102, 103 and are opposite to the image capturing unit 20 and the optical signal emitting unit 30.

The optical signal emitting unit 30 emits a light 31 carrying with modulation signal which is guided into the guide light plate 10 to conduct total internal reflection propagation inside the guide light plate 10. The light 31 covers a range over 90 degrees to irradiate the entire internal area of the guide light plate 10 and the two reflection films 82. The upper surface 11 of the guide light plate 10 forms an operation zone 100 corresponding to the entire internal area irradiated by the light 31. The modulation signal can be a modulation frequency, amplitude or phase signal of the light 31. The optical signal emitting unit 30 includes a LASER plane optical signal emitting unit.

The image capturing unit 20 includes a photosensitive array 21 and a lens 22; the lens 22 is disposed next to the first guide light unit 60. Light reflected by the two reflective films 82 are guided by the first guide light unit 60 to irradiate the photosensitive array 21 via the lens 22; the image capturing unit 20 captures a strip image of the inside of the guide light plate 10 with the lens 22.

The optical signal processing unit 50 is electrically connected to the image capturing unit 20 and the microprocessor 40 respectively. The optical signal processing unit 50 detects multiple modulation signals output by the photosensitive array 21 of the image capturing unit 20, processes the modulation signals to obtain multiple signals corresponding to the multiple modulation signals of the photosensitive array 21, and transmits these signals to the microprocessor 40.

The optical signal emitting unit 30 simultaneously emits lights 31, 32, 33 carrying with modulation signals which are guided into the guide light plate 10 by the second guide light unit 70 and irradiates the entire operation zone 100 and the two reflection films 82. When the two reflection films 82 disposed at the two sides 102, 103 are shot by the lights, the lights are reflected back to inside the guide light plate 10 by the two reflection films 82 to shoot the two retro-reflectors 81 respectively, the two retro-reflectors 81 reflect the lights back to the two reflection films 82 via the original paths, and the reflection films 82 further reflect the lights to the optical signal emitting unit 30. Due to the lights having a property of spreading at the time of propagation, the lights 31, 32, 33, which are reflected to the optical signal emitting unit 30, shoot the first guide light unit 60 disposed next to the optical signal emitting unit 30 as well and guided to the image capturing unit 20 by the first guide light unit 60.

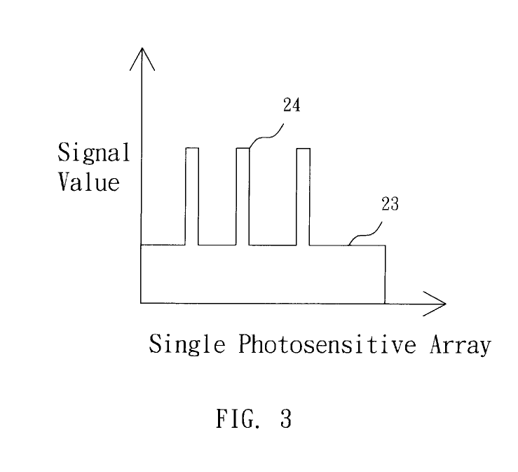

If an object 90 dose not touch the upper surface 11 of the guide light plate 10, the optical signal emitting unit 30 emits the light 31 carrying with a modulation signal to propagate in the guide light plate 10 and be reflected to the photosensitive array 21 by the two reflection films 82; meanwhile, only the carried modulation signal is transmitted to the optical signal processing unit 50 such that the optical signal processing unit 50 receives a normal signal value 23 corresponding to the modulation signal as shown in FIG. 3.

If the object 90 is in the operation zone 100 to operate touch work and contact the upper surface of the guide light plate 10, the guide light plate 10 is induced to vibrate to result in that the lights 31, 32, 33, which pass through a corresponding touch point P, carry newly generated low frequency vibration signals or further generate FTIR signals; there are three photosensitive components 221 in the photosensitive array 22 sensing the lights 31, 32, 33 and outputting the newly generated low frequency vibration signals or generating one of the FTIR signals so as to allow the optical signal processing unit 50 to obtain three unusual signal values 24; most of the lights, which are not corresponding to the touch point P, only carry the original modulation signals and are transmitted to the optical signal processing unit 50 such that the optical signal processing unit 50 obtains most of the normal signals 23 corresponding to the original modulation signals as shown in FIG. 3.

The microprocessor 40 detects the signal values sequentially output by the optical signal processing unit 50 corresponding to each of the photosensitive components 211 of the photosensitive array 21, and locations of corresponding photosensitive components 21 can be obtained based on time points with respect to unusual signal values detected in a period; once the locations of the photosensitive components 211 are found, corresponding lights can be obtained such that angles between respective lights and the side 101 are able to be obtained as well. According to the respective angles between at least two lights passing through the touch point P and the side 101 and applying trigonometry formulas such as the related calculation method disclosed in U.S. Pat. No. 4,762,990, coordinates of the touch point P in the operation zone 100 can be figured out.

Hence, the microprocessor 40 calculates the coordinate information of the touch point P in the operation zone 100 based on the preceding calculation method and outputs a corresponding touch signal.

Taiwan Patent Publication No. 2013421161, which is filed by the present applicant and entitled “LASER scan input device”, discloses a coordinate calculation technique capable of being applied in the present invention as well with which the microprocessor 40 detects signals sequentially output by the optical signal processing unit 50 in a period, then obtains location information of the touch point based on time points of at least two unusual signal values appearing in a period respectively, and further outputs a corresponding touch signal.

It also can be done with conducting tests and records of the location of the touch point on the upper surface of the guide light plate and information related to at least two time points with respect to the unusual signals output by the optical signal processing unit in a period; then, according to the preceding information, the microprocessor obtains location information of the touch point on the upper surface of the guide light plate based on the two time points of the unusual signal values output by the optical signal processing unit in a period.

It also works well with only one retro-reflector 81 being used instead in the present invention to contact the guide light plate 10 corresponding to the peripheral surface 13 at one of the two sides 101, 102, or only one retro-reflector 81 is disposed to be opposite to the image capturing unit 21; for instance, the retro-reflector 81 is disposed to contact the guide light plate 10 corresponding to the peripheral surface 13 at one of the two sides 102, 103; the peripheral surface 13 at other sides of the guide light plate 10 without corresponding to the retro-reflector 81 is adhered with a reflection film 82 respectively, that is, any arrangements, which allow the lights emitting from the optical signal emitting unit 30 and irradiating the operation zone 100 to retro-reflect to the image capturing unit 20 next to the optical signal emitting unit 30, can achieve the identical effect.

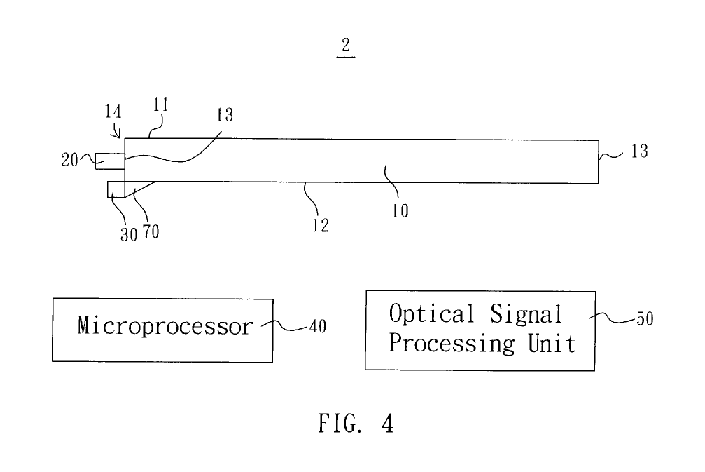

Referring to FIG. 4, the second embodiment of a guide light plate optical touch device 2 according to the present invention provides a structure similar to the first embodiment except no need to provide the first guide light unit 60 and the image capturing unit 20 being disposed outside a corner 14 to take the inside image of the guide light plate 10 such that the second embodiment is capable of achieving the same effect as the first embodiment. The present embodiment is applied to thicker guide light plate 10. and the image capturing unit 20 are able to take the inside image of the guide light plate 10 via the peripheral surface 13 of the guide light plate 10 directly.

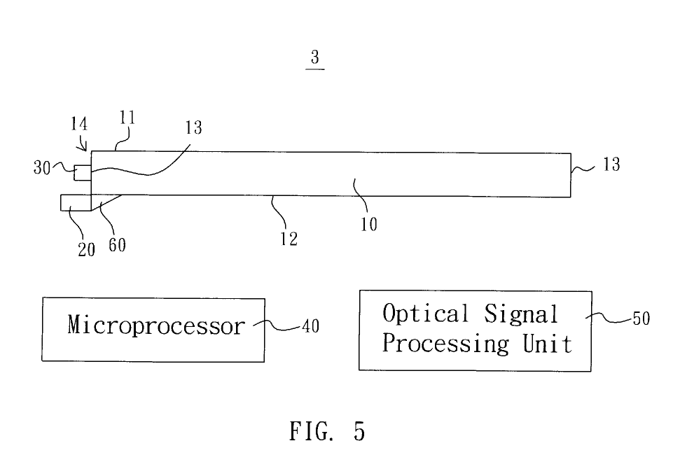

Referring to FIG. 5, the third embodiment of a guide light plate optical touch device 3 according to the present invention provides a structure similar to the first embodiment except no need to provide the second guide light unit 70 and the optical signal emitting unit 30 being disposed outside a corner 14 to emit the lights into the guide light plate 10 directly such that the third embodiment is capable of achieving the same effect as the first embodiment does. The present embodiment is applied to thicker guide light plate 10. and the optical signal emitting unit 30 is able to emit the lights into the guide light plate 10 via the peripheral surface 13 of the guide light plate 10 directly.

It is appreciated that the characteristics is in that at the time of the guide light plate being touched, at least two of the lights passing through the touch point P carry newly generated low frequency vibration signal or further generate FTIR signals to result in the optical signal processing unit to obtain at least two unusual signals, then the microprocessor detects signals sequentially output by the optical signal processing unit in a period, obtains the location information of the touch point based on time points of at least two unusual signal values appearing in a period, and further outputs a corresponding touch signal.

It is noted that even if the area of a touch point is extremely small such as the tip of a tooth pick touching the guide light plate, the lights passing through the touch point are capable of carrying the newly generated low frequency vibration signal to obtain the location information of the touch point such that it enhances the function of the touch device practically.

Further, the respective light emitted by the optical signal emitting unit of the present invention covers a range over 90 degrees to irradiate the entire area inside the guide light plate such that no scanning device is required so as to lower the cost and reduce the volume of the touch device of the present invention.

In addition, the image capturing unit of the present invention includes a photosensitive array and a lens with which the lens captures a large area image with small area photosensitive array so as to lower the cost as well instead of large area multiple photosensitive components being arranged to surround the guide light plate.

Although the invention has been described in relation to its preferred embodiments, it is to be understood that many other possible modifications and variations can be made without departing from the spirit and scope of the invention as hereinafter claimed.

What is claimed is:

1. A guide light plate optical touch device, comprising:
a guide light plate having a peripheral surface, a lower surface and an upper surface with an operation zone;
at least a strip-shaped retro-reflector;
at least a strip-shaped reflection films;
a microprocessor;
an optical signal emitting unit disposed near a corner of the guide light plate;
an image capturing unit disposed near said optical signal emitting unit, and including a photosensitive array and a lens, the photosensitive array providing a plurality of photosensitive units;
an optical signal processing unit electrically connecting with said microprocessor and said image capturing unit, detecting signals output by the photosensitive units, processing the signals and obtaining a plurality of signal values corresponding to the signals of the photosensitive units, and transmitting the signal values to the microprocessor;
wherein at least one of said retro-reflectors and one of said reflector films are disposed at the peripheral surface of the guide light plate to guide lights emitted by said optical signal emitting unit into the guide light plate, retro-reflect the lights toward the optical signal emitting unit, and further guide the light into the image capturing unit; when the operation zone on the upper surface of the guide light plate is touched, at least two of the photosensitive units of said photosensitive array sense at least two lights passing through a touch point and output an newly generated low frequency vibration signal respectively, or generating at least one of FTIR signals to allow the optical signal processing unit to obtain two unusual signal values; the microprocessor detects the signal values output by the optical signal processing unit sequentially in a period and obtains location information of the touch point based on time points corresponding to the two unusual signal values appearing in the period, and outputs a corresponding touch signal.

2. The guide light plate optical touch device as defined in claim 1, further comprising a first guide light unit; said image capturing unit is disposed under the lower surface of the guide light plate; the first guide light unit contacts the lower surface; the lights, which are retro-reflected toward the optical signal emitting unit, are guided into the image capturing unit by the first guide light unit.

3. The guide light plate optical touch device as defined in claim 1, further comprising a second guide light unit; said optical signal emitting unit is disposed under the lower surface of the guide light plate; the second guide light unit contacts the lower surface; the lights, which are emitted by the optical signal emitting unit, are guided into the guide light plate by the second guide light unit.

4. The guide light plate optical touch device as defined in claim 2, further comprising a second guide light unit; said optical signal emitting unit is disposed under the lower surface of the guide light plate; the second guide light unit contacts the lower surface; the lights, which are emitted by the optical signal emitting unit, are guided into the guide light plate by the second guide light unit.

5. The guide light plate optical touch device as defined in claim 1, wherein the lights emitted by said optical signal emitting unit carry modulation signals; most of the photosensitive units sense most of the lights which do not pass through the touch point and output most of the modulation signals to allow the optical signal processing unit to obtain most normal signals corresponding to the modulation signals.

6. The guide light plate optical touch device as defined in claim 5. wherein said guide light plate is rectangular-shaped with four sides; the peripheral surface of the guide light plate at two of the sides contacts two retro-reflectors; said two retro-reflectors have an end thereof close to the optical signal emitting unit respectively; the peripheral surface of the guide light plate at other two sides are adhered with two reflection films respectively.

7. The guide light plate optical touch device as defined in claim 5, wherein said guide light plate is rectangular-shaped with four sides; the peripheral surface of the guide light plate at one of the sides contacts one retro-reflector; the peripheral surface of the guide light plate at other three sides are adhered with three reflection films respectively.

8. The guide light plate optical touch device as defined in claim 5, wherein the upper surface of the guide light plate forms said operation zone corresponding to an internal area with which the lights propagates in the guide light plate.

9. The guide light plate optical touch device as defined in claim 6, wherein said guide light plate is made of guide light material in a form of bendable or unbendable plate; the optical signal emitting unit is LAER plane light emitting unit; the first and second guide light units are optical prisms with triangle cross-sections.

10. The guide light plate optical touch device as defined in claim 7, wherein said guide light plate is made of guide light material in a form of bendable or unbendable plate; the optical signal emitting unit is LAER plane light emitting unit; the first and second guide light units are optical prisms with triangle cross-sections.

11. The guide light plate optical touch device as defined in claim 4, wherein the lights emitted by said optical signal emitting unit carry modulation signals; most of the photosensitive units sense most of the lights which do not pass through the touch point and output most of the modulation signals to allow the optical signal processing unit to obtain most normal signals corresponding to the modulation signals.

12. The guide light plate optical touch device as defined in claim 11, wherein said guide light plate is rectangular-shaped with four sides; the peripheral surface of the guide light plate at two of the sides contacts two retro-reflectors; said two retro-reflectors have an end thereof close to the optical signal emitting unit respectively; the peripheral surface of the guide light plate at other two sides are adhered with two reflection films respectively.

13. The guide light plate optical touch device as defined in claim 11, wherein said guide light plate is rectangular-shaped with four sides; the peripheral surface of the guide light plate at one of the sides contacts one retro-reflectors; the peripheral surface of the guide light plate at other three sides are adhered with two reflection films respectively.

14. The guide light plate optical touch device as defined in claim 11, wherein the upper surface of the guide light plate forms said operation zone corresponding to an internal area with which the lights propagates in the guide light plate.

15. The guide light plate optical touch device as defined in claim 12, wherein said guide light plate is made of guide light material in a form of bendable or unbendable plate; the optical signal emitting unit is LAER plane light emitting unit; the first and second guide light units are optical prisms with triangle cross-sections.

16. The guide light plate optical touch device as defined in claim 13, wherein said guide light plate is made of guide light material in a form of bendable or unbendable plate; the optical signal emitting unit is LAER plane light emitting unit; the first and second guide light units are optical prisms with triangle cross-sections.
